(19) United States
(12) Patent Application Publication
(10) Pub. No.: US 2006/0184897 A1
(43) Pub. Date: Aug. 17, 2006

(54) Information retrieval apparatus and method

(76) Inventor: Yisia Young Suk Lee, London (GB)

Correspondence Address: KATTEN MUCHIN ROSENMAN LLP, 525 WEST MONROE STREET, CHICAGO, IL, 60661-3693, US

(21) Appl. No.: 11/292,274

(22) Filed: Dec. 2, 2005

Related U.S. Application Data
(63) Continuation-in-part of application No. PCT/GB04/02332, filed on Jun. 1, 2004.

(30) Foreign Application Priority Data
Jun. 2, 2003 (GB) 0312629.9

(51) Int. Cl. G06F 17/00

(52) U.S. Cl. 715/810

(57) ABSTRACT

Apparatus for retrieving information from at least one information source, the information being indexed or arranged by an indexing scheme or arrangement that defines an information hierarchy, the apparatus comprising: a display for displaying information and user selectable menu items; a user input device for receiving user selections of displayed menu items; retrieving means for retrieving information from said information source(s); said information source(s) containing information at a plurality of hierarchical levels, said information being distinct from a name of said displayable menu items; and a display controller adapted to control said display in dependence upon received user selections to display said menu items as history menu items indicating received user selections corresponding to navigation down levels of the hierarchy of said information source(s), and new menu items corresponding to information available at a next level of the hierarchy of said information source(s); wherein said retrieving means is adapted to retrieve only information corresponding to a most recently selected menu item for a current level of the hierarchy in said information source(s) in response to a most recent user selection, and said display controller is adapted to display said retrieved information for the current level of the hierarchy in a display region separate to said history menu items, whereby the only said information that is displayed in said separate display region is said retrieved information.

The present invention relates to an apparatus and method for information retrieval, and in particular, to an apparatus and method for retrieving information from a source of hierarchically arranged information, including, for example, information that is arranged by a filing system to define a hierarchical structure, or information that is indexed in a manner to define a hierarchy.

Information may often be conveniently indexed using a hierarchical directory structure. It is desirable to make it easy for a user to navigate through the hierarchical directory structure to locate information of interest to the user, and to provide an efficient menu based navigation system.

Alternatively, information may be indexed using an indexing system that defines a hierarchical structure for organising the information. For example, different parts of the information may be associated with different labels or definitions, defining the location in the hierarchical structure. The information may be divided into data files, and the given filenames, or information stored within the files, may define the location in the hierarchical structure. Alternatively, an index that is separate from the files, e.g. in the form of a list, may be provided, in order to define the hierarchical structure.

Hierarchically indexed information may be stored using a storage structure that is organised in a different way from the hierarchical structure defined by the indexing scheme. For example, information may be physically stored using a non-hierarchical storage arrangement, such as in the form of multiple data files within a single directory on a disk drive or other storage means. Alternatively, information may be stored in a hierarchical storage structure that is organised differently to the hierarchical information structure, such as within a system of directories on a disk drive or other storage means, and/or in a plurality of different network locations. It is desirable to make it easy for a user to navigate through a hierarchy of information organised in such a way.

In currently known navigation systems such as web browsers, a “back” button may be provided to allow a user to retrace their path, and a “forward” navigation button may also be provided. However, the “forward” navigation button works only by returning to the original location after the user has made use of the “back” button. If the user has not made use of the “back” button, the “forward” navigation button is not activated, because there is no forward navigation strategy.

The present invention provides an apparatus for retrieving information from at least one source of hierarchical information, and an equivalent method. The apparatus has output means for outputting the information to the user and for outputting user selectable menu items to the user, input means for receiving a user selection of information to be displayed, and control means for controlling the output means to output both history items and new menu items to the user. The history items are previously received user selections, and the new menu items are a list of information available at a next level of the information hierarchy. The information corresponding to the most recently selected menu item is output to the user.

Thus the present invention provides a useful interface which allows for easy navigation of a hierarchically organised information store using the history menu as well as the new information menu.

In a specific embodiment, new menu items can be displayed either by selecting a history menu item, in which case the new menu items correspond to the next level of the hierarchy below the position in the hierarchy corresponding to the history menu item, or new menu items can be displayed for a next level of the hierarchy corresponding to the currently displayed information i.e. the most recently selected menu item.

The present invention has the advantage that it allows information relating to both general categories and very specific sub-categories to be displayed to the user. It thus provides a useful tool for navigation and output of information from a hierarchical information source.

In the present invention, a display is configured to display the history list at the same time as displaying the information, allowing rapid and easy navigation through the directory structure, whilst simultaneously showing the selected information. In one embodiment of the present invention, separate screen areas are allocated to displaying the information, and displaying the history list.

The present invention may be used with any computer, including handheld devices such as PDAs (personal digital assistants), electronic book readers, mobile phones, digital audio players, GPS (global positioning satellite) receivers, etc. Where the present invention is used with a computer having a small screen, such as in a handheld device, an embodiment of the present invention provides the considerable advantage of allowing very efficient use of the limited display area available on the screen.

The information in the information source may include text, web pages, photographs, images or video images for displaying on a screen, and/or audio information, such as digital speech or music, for outputting through a speaker. The information may be physically stored as an information hierarchy, or the information may be indexed by a hierarchical node structure. At least some of the information may be generated dynamically when a user input is received to navigate to that information. Such dynamically generated information may be accessed from one or more physical location.

The information may all be stored in a single physical location, such as a disc drive, or may be distributed amongst a plurality of physical locations, which may be connectable via one or more networks. The information may be stored within a directory structure which at least partially corresponds to the structure of the information hierarchy, e.g. information at the top level of the hierarchy may be stored in top level directories, and information at lower levels of the hierarchy may be stored in subdirectories. Alternatively, the information may be stored within a file structure that does not correspond to the structure of the information hierarchy. One example is where the information in the information source is all stored within a single directory, and the hierarchical information structure is defined by indexing means such as by filenames or labels associated with each file in the information source, or by using an index or list containing information on the hierarchical structure.

For example, a first part of the filename or label may define a position in the hierarchy, a second part of the filename or label may define a branch of the hierarchy below the first defined position, and subsequent parts of the filename or label may define sub-branches of the hierarchy. Thus, the filename or label may specify the route from the top of the hierarchy to the location of the named or labelled information within the hierarchy. An information source may be constructed of a plurality of files stored within a single directory on a computer storage device, or stored in distributed physical locations or virtual locations, and the hierarchical structure be defined by associated filenames or labels. Part of the filename or label may relate to the position of the file in the hierarchy, or the entire filename or label may determine this.

The labelling to define a hierarchy can easily be processed by computer programming languages, e.g. XML (Extensible markup language), PHP (PHP Hypertext Pre-processor) and SQL (Structured Query Language), which may thus be used to identify the next item of information to be retrieved when a user selects a menu item.

The information source(s) may be provided on a computer, together with code for configuring the computer as an apparatus according to the present invention, or the information source(s) may be separate or remote from the apparatus, whereby the information is accessed by the apparatus e.g. over a communications link. Alternatively the information may be provided separately or remotely from the apparatus and the apparatus accesses the information e.g. over a network.

The information source(s) may include information which is arranged in a hierarchical structure corresponding to a network of hierarchically interlinked nodes. The individual items of information making up the information source are each associated with a node. The structure may have a single top level node or “root” node, which is interlinked to each node lower in the hierarchy. The top level node may be interlinked to each node lower in the hierarchy via a unique path, or via a choice of alternative paths. Each node may be associated with a node reference which is used to identify the node, such as a node name, label or ID number.

The apparatus of the present invention may include a touch sensitive screen, which may be activated using a variety of methods such as by a person's finger or using a stylus. The apparatus may include a loudspeaker, for playback of audio information. However, the present invention is not limited to such a technology or design.

Menu items may be selected using a pointer displayed on the display, for example, a pointer linked to a mouse or other input device. Alternatively, menu items may be selected without a pointer being displayed on the screen, e.g. by use of a touch sensitive screen, and touching the part of the screen corresponding to the menu item. Menus may be activated and items selected by the positioning of the pointer on the screen, and by clicking the pointer, or by single or multiple touches to a touch sensitive screen.

The source of hierarchically arranged or indexed information may be provided on a computer, together with code for configuring the computer as an apparatus according to the present invention, or the information source may be separate or remote from the apparatus, whereby the information is accessed by the apparatus e.g. over a communications link. Alternatively the information is provided separately or remotely from the apparatus and the apparatus accesses the information e.g. over a network.

In one embodiment, the information source includes information which is arranged in a network of hierarchically interlinked nodes. The individual items of information making up the information source are each associated with a node. The structure has a single top level node, which is interlinked to each node lower in the hierarchy. The top level node is interlinked to each node lower in the hierarchy via a unique path, or via a choice of alternative paths. The history menu will preferably show the route which has actually been taken by the user, rather than a different one of these alternative paths. Each node may be associated with a node reference which is used to identify the node, such as a node name, label or ID number.

The invention still has high utility even when the hierarchical information includes some nodes with no data. For those nodes, no information is shown, so the benefit of the invention is not achieved. However, the benefit of the invention is still achieved for the remainder of the nodes which do have associated information.

The hierarchically arranged information may include information which is not simply the node reference, and which relates to the configuration of the information hierarchy and/or to the presentation of the menus on the screen. The hierarchically arranged information may include information which relates to neither the configuration of the information hierarchy nor to the presentation of the menus on the screen. The information may include text, web pages, photographs, images or video images for displaying on a screen, and/or audio information, such as digital speech or music, for outputting through a speaker.

The present invention can be implemented by software or programmable computing apparatus. This includes any computer, including PDAs (personal digital assistants), mobile phones, etc. Thus the present invention encompasses a carrier medium carrying computer readable code for configuring a computer or number of computers as the apparatus of the invention. The carrier medium can comprise a transient medium, e.g. an electrical, optical, microwave, RF, electromagnetic, acoustic or magnetic signal (e.g. a TCP IP signal over an IP network such as the internet), or a carrier medium such as a floppy disk, CD ROM, hard disk, or programmable memory device.

Preferred embodiments of the invention will now be described by way of example only, with reference to the accompanying drawings, in which:

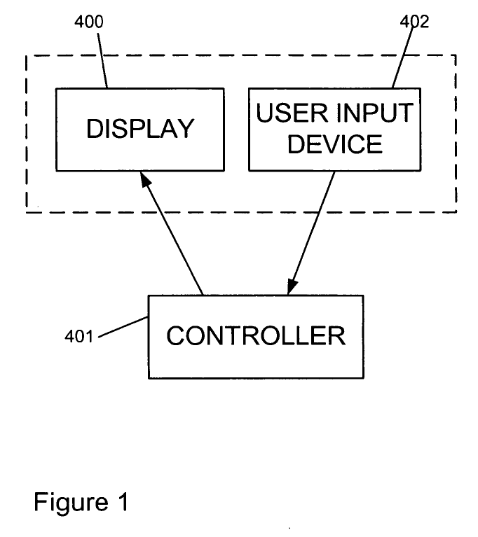

FIG. 1 is a block diagram showing the apparatus according to an embodiment of the invention;

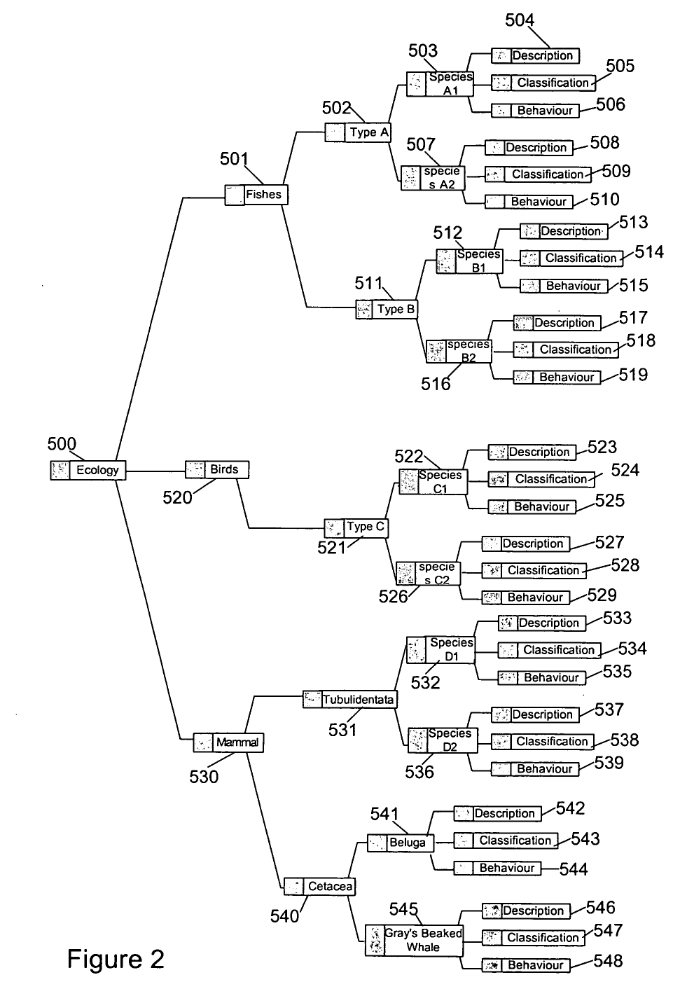

FIG. 2 is a tree diagram showing the information structure of the information source used in a first embodiment of the invention;

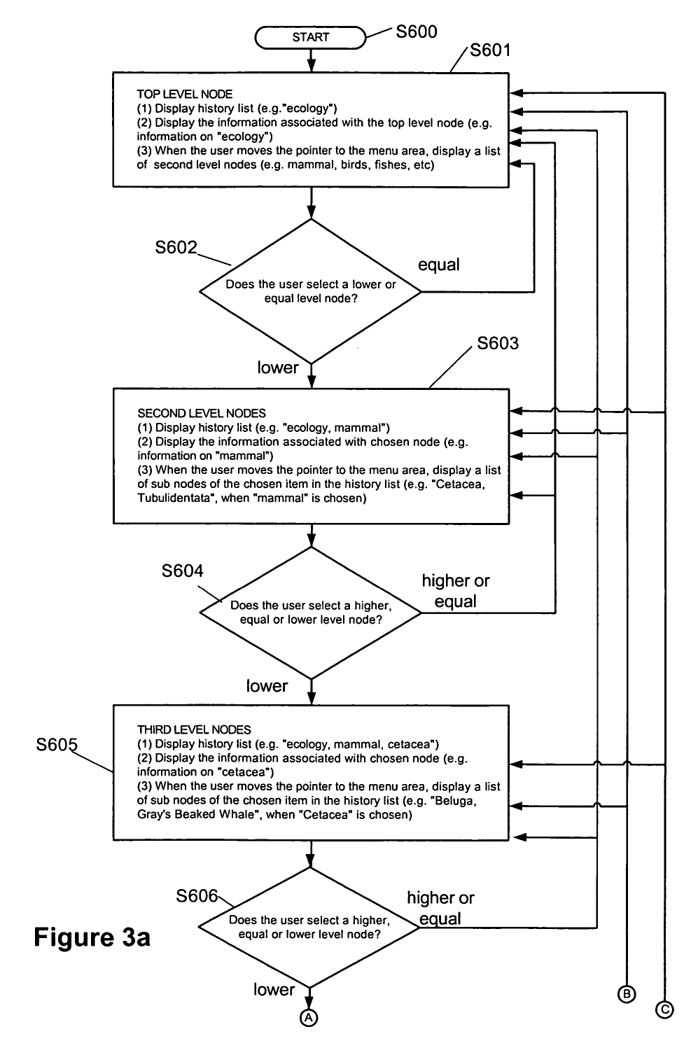

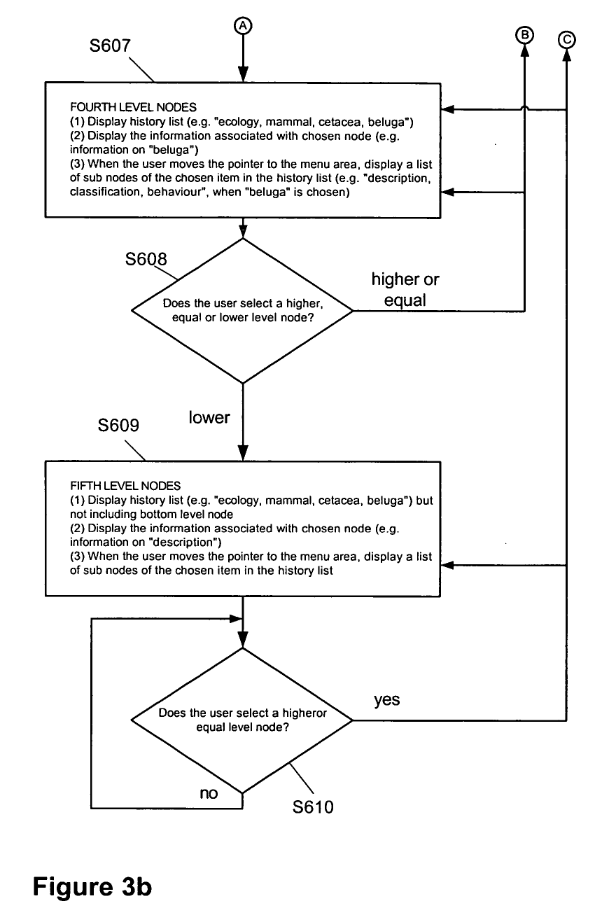

FIGS. 3a and 3b are a flowchart showing a process for locating information according to an embodiment of the invention;

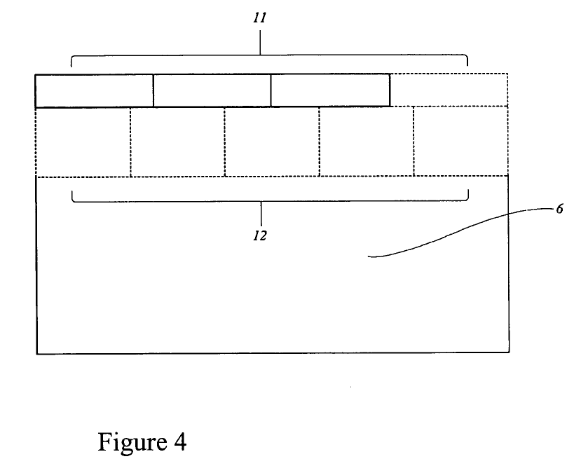

FIG. 4 is a screen layout showing the layout of information on a computer display used in an embodiment of the invention;

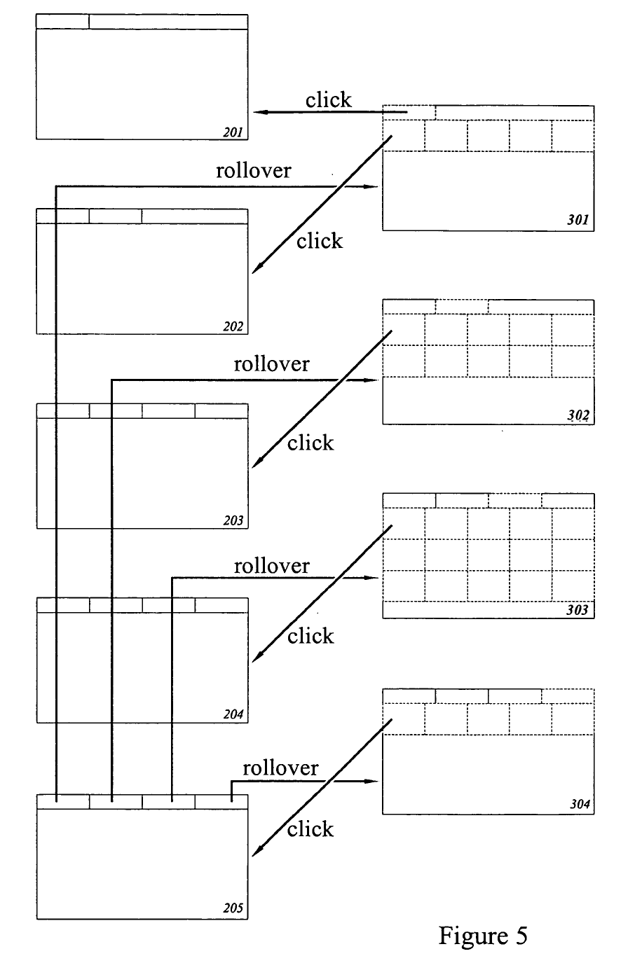

FIG. 5 shows a plurality of screen layouts for different stages in the navigation process in the embodiment of FIG. 4, and arrow indicate the way in which these screen layouts are interlinked;

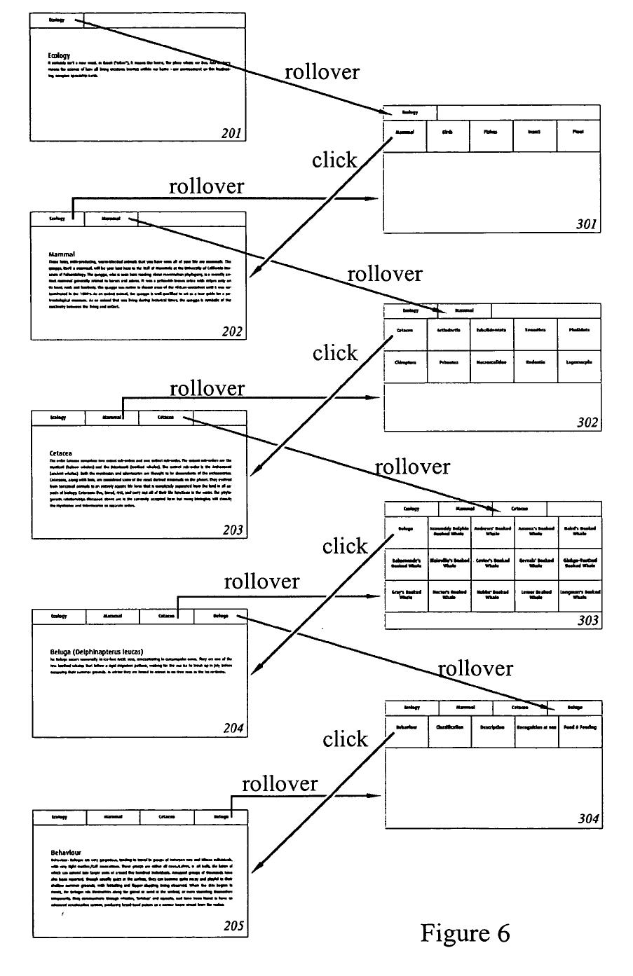

FIG. 6 shows the screen layouts of FIG. 5, when used with an example database;

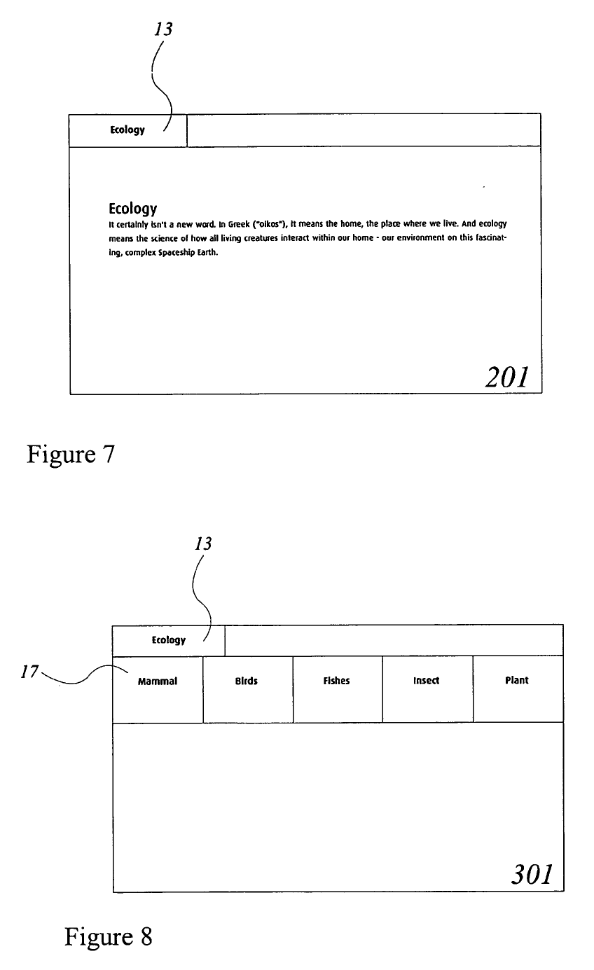

FIG. 7 is an enlarged computer screenshot for the top level information output, in the embodiment of FIG. 6;

FIG. 8 is an enlarged computer screenshot for the top level drop-down menu, in the embodiment of FIG. 6;

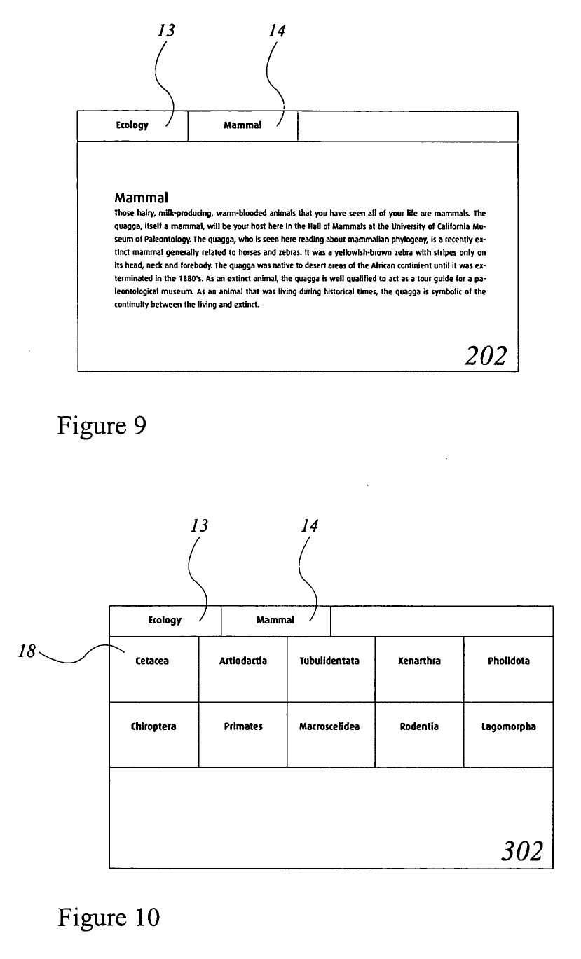

FIG. 9 is an enlarged computer screenshot for the second level information output, in the embodiment of FIG. 6;

FIG. 10 is an enlarged computer screenshot for the second level drop-down menu, in the embodiment of FIG. 6;

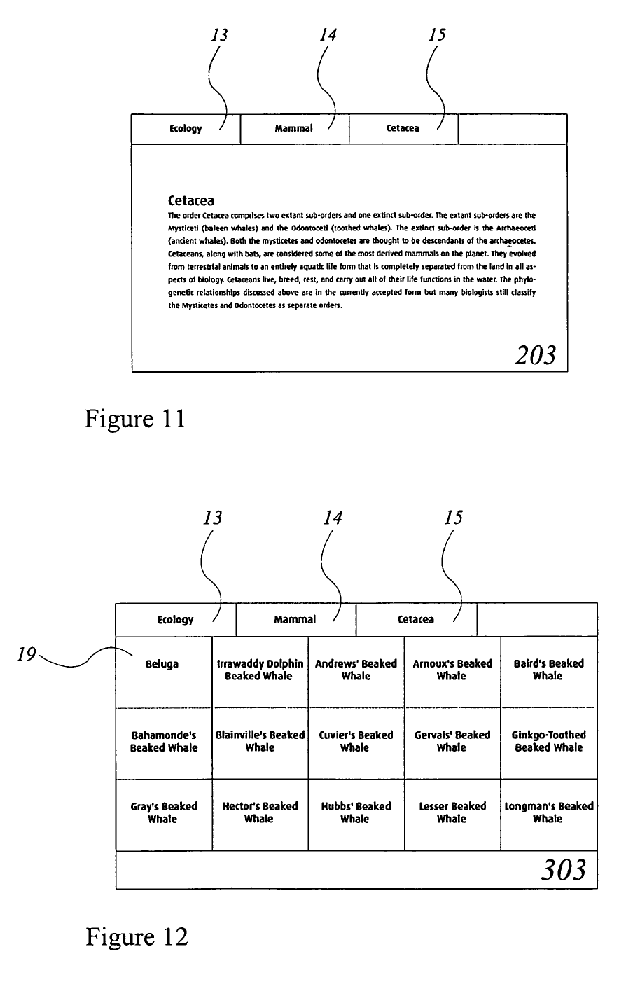

FIG. 11 is an enlarged computer screenshot for the third level information output, in the embodiment of FIG. 6;

FIG. 12 is an enlarged computer screenshot for the third level drop-down menu, in the embodiment of FIG. 6;

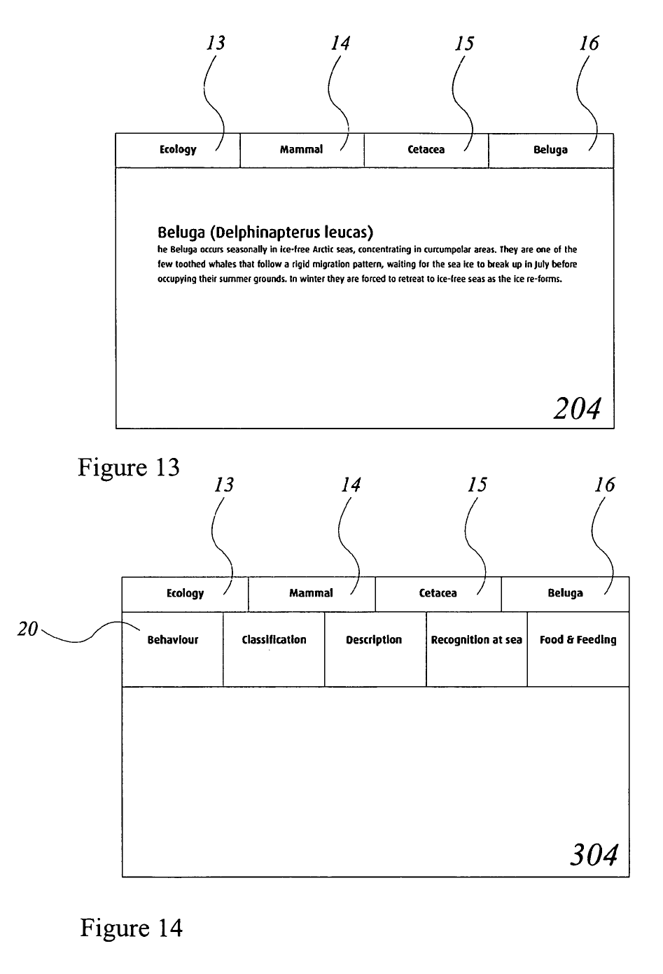

FIG. 13 is an enlarged computer screenshot for the fourth level information output, in the embodiment of FIG. 6;

FIG. 14 is an enlarged computer screenshot for the fourth level drop-down menu, in the embodiment of FIG. 6; and

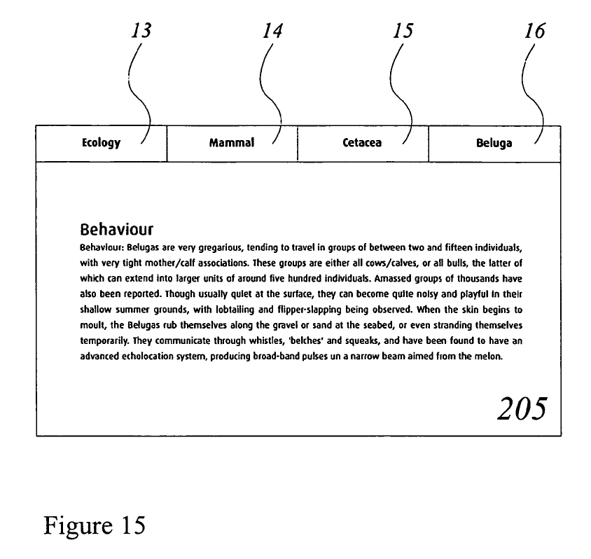

FIG. 15 is an enlarged computer screenshot for the fifth and bottom level information output, in the embodiment of FIG. 6;

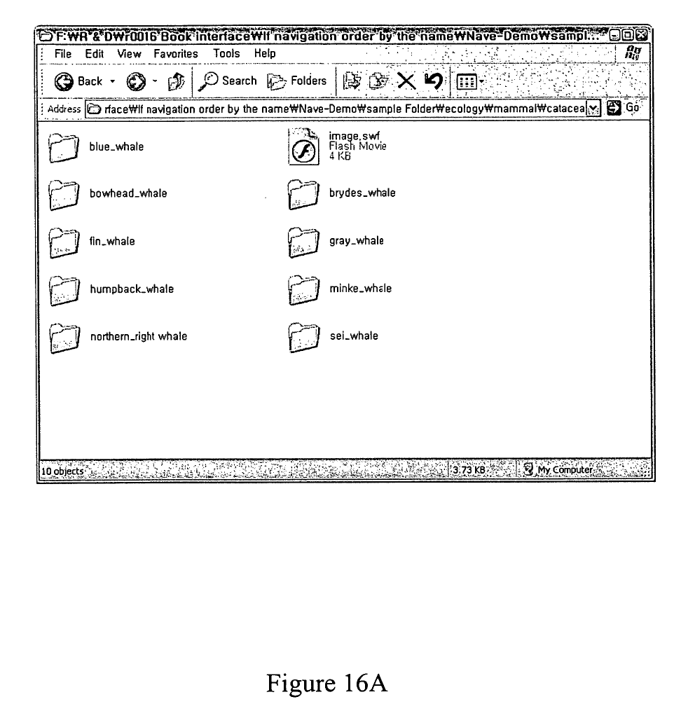

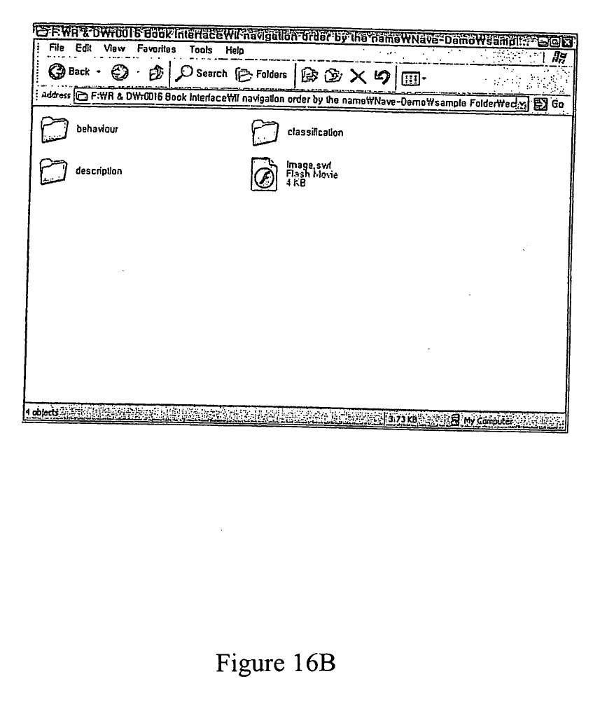

FIGS. 16a and 16b are computer screenshots displaying part of a directory structure which corresponds to the hierarchical information structure in one embodiment of the invention;

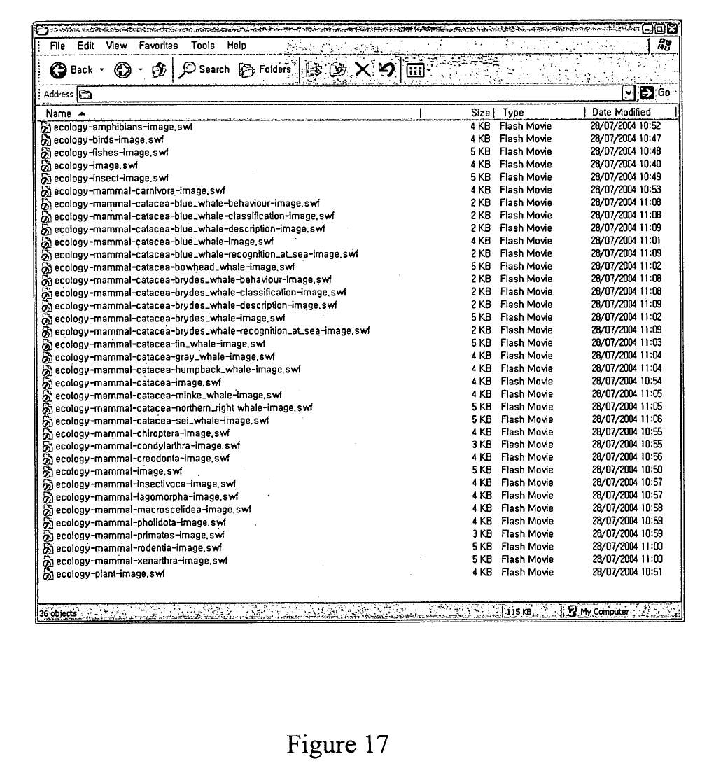

FIG. 17 is a computer screenshot displaying the contents of a single directory in a computer file system, comprising files corresponding to a plurality of levels of the hierarchy, in another embodiment of the invention;

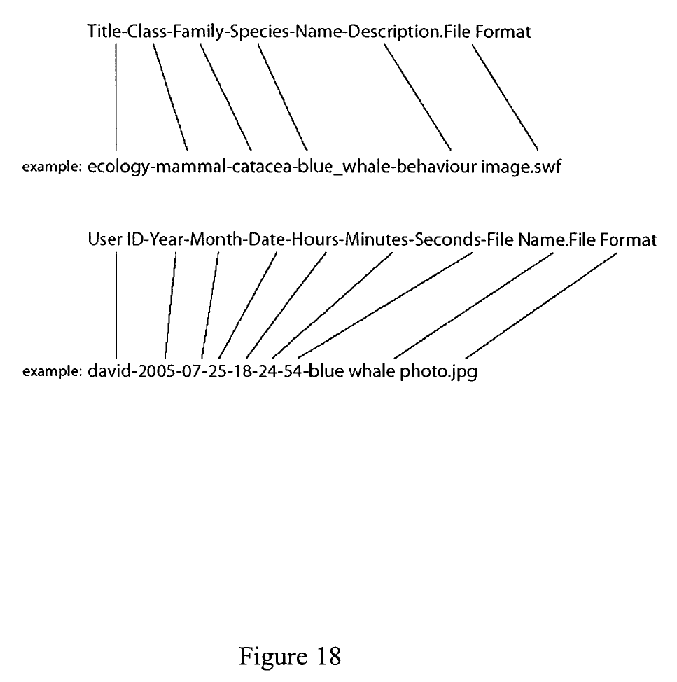

FIG. 18 shows examples of how a filename can be used to define the location of a file within an information hierarchy;

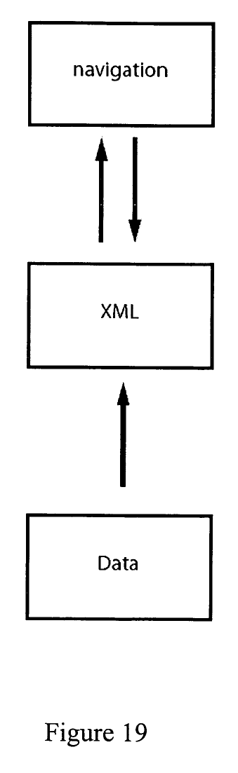

FIG. 19 is a schematic diagram indicating the data flow between a navigation interface, an XML processor and data from an information source, in an embodiment of the invention;

FIG. 1 is a block diagram showing the apparatus according to an embodiment of the invention. The apparatus has a display 400, a controller 401, and a user input device 402. The display 400 and the user input device 402 are both connected to the controller 401, such that information passes from the controller 401 to the display 400, and from the user input device 402 to the controller 401. The user input device 402 may be integral with the display 400, or may be separate, as indicated by the dashed line surrounding both the display 400 and the user input device 402. Optionally the apparatus may include an information store storing the hierarchically organised information to be accessed. Alternatively the information store is not part of the apparatus and in this case the apparatus includes an interface for accessing the information store. The interface can comprise a port or connector to allow the apparatus to be connected in a computer apparatus to access the information store, or the interface can comprise a network interface.

FIG. 2 shows a hierarchical information structure. The structure is a tree shape, with a top level directory 500, and a number of second level directories 501, 520, 530 linked to the top level directory 500 by branches. Each directory may be considered to be a node in the hierarchy, and the nodes are connected together by the branches. Second level node 501 is connected to third level nodes 502, 511, second level node 520 is connected to third level node 521, and second level node 530 is connected to third level nodes 531 and 540. Each of these third level nodes is connected to two fourth level nodes 503, 507, 512, 516, 522, 526, 532, 536, 541, 545. Each fourth level node is connected to a fifth level node 504, 505, 506, 508, 509, 510, 513, 514, 515, 517, 518, 519, 523, 524, 525, 527, 528, 529, 533, 534, 535, 537, 538, 539, 542, 543, 544, 546, 547, 548, at the bottom of the hierarchical structure. Each node has a node name. Each node at each level of the hierarchy is associated with an item of information, which is represented in the figure by a grey shaded box adjascent to the node name. In the present example, the information relates to ecology, and the top level node 500 is named “Ecology”. The second level nodes are name “Fishes”, “Birds” and “Mammal”. Similarly, the third level nodes are named as subsets of the second level nodes, and the fourth level nodes are named as subsets of the fourth level nodes. The fifth level nodes are named “description”, “classification” or “behaviour”, and in this example, the fifth level is the bottom of the hierarchy.

In the present invention, it is not essential that all bottom level nodes are all at the same level in the hierarchy, nor is it essential that the nodes above the bottom level have only one, two or three immediate sub-nodes.

FIGS. 3a and 3b show a flowchart of a process of navigation through a hierarchical information structure to find a required item of information. The process begins at step S600. At step S601, the apparatus presents the user with a history list containing only the name of the top level node 500 in the hierarchy, which is “ecology”. The apparatus also displays the information relating to the top level node. If the user moves the pointer over “ecology” in the history list, a list of second level nodes 501, 520, 530 in the hierarchy is displayed. At step S602, the user may select one of these second level nodes. If the user selects the top level node, the process returns to step S601. However, if the user selects a second level node, the process proceeds to step S603.

At step S603, the apparatus presents the user with a history list containing the name of the top level node 500, and the selected second level node, e.g. “mammal” 530. The apparatus also displays the information relating to the selected second level node 530. If the user moves the pointer over “ecology” in the history list, a list of second level nodes 501, 520, 530 in the hierarchy is displayed. If the user moves the pointer over “mammal” in the history list, a list of third level nodes 531, 540 in the hierarchy is displayed. At step S604, the user may select one of these second or third level nodes. If the user selects the top level node or a second level node, the process returns to the appropriate part of the flow chart. However, if the user selects a second level node, the process proceeds to step S605.

At step S605, the apparatus presents the user with a history list containing the name of the top level node 500, the selected second level node, e.g. “mammal” 530, and the selected third level node, e.g. “cetacea” 540. The apparatus also displays the information relating to the selected third level node 540. If the user moves the pointer over “ecology” in the history list, a list of second level nodes 501, 520, 530 in the hierarchy is displayed. If the user moves the pointer over “mammal” in the history list, a list of third level nodes 531, 540 in the hierarchy is displayed. If the user moves the pointer over “cetacea” in the history list, a list of fourth level nodes 541, 545 in the hierarchy is displayed. At step S606, the user may select one of these second, third or fourth level nodes. If the user selects the top level node, a second level node or a third level node, the process returns to the appropriate part of the flow chart. However, if the user selects a fourth level node, the process proceeds to step S607.

At step S607, the apparatus presents the user with a history list containing the name of the top level node 500, the selected second level node, e.g. “mammal” 530, the selected third level node, e.g. “cetacea” 540, and the selected fourth level node, e.g. “beluga” 541. The apparatus also displays the information relating to the selected fourth level node 541. If the user moves the pointer over “ecology” in the history list, a list of second level nodes 501, 520, 530 in the hierarchy is displayed. If the user moves the pointer over “mammal” in the history list, a list of third level nodes 531, 540 in the hierarchy is displayed. If the user moves the pointer over “cetacea” in the history list, a list of fourth level nodes 541, 545 in the hierarchy is displayed. If the user moves the pointer over “beluga” in the history list, a list of fifth level nodes 542, 543, 544 in the hierarchy is displayed. At step S608, the user may select one of these second, third, fourth or fifth level nodes. If the user selects the top level node, a second level node, a third level node or a fourth level node, the process returns to the appropriate part of the flow chart. However, if the user selects a fifth level node, the process proceeds to step S609.

At step S609, the apparatus presents the user with a history list containing the name of the top level node 500, the selected second level node, e.g. “mammal” 530, the selected third level node, e.g. “cetacea” 540, and the selected fourth level node, e.g. “beluga” 541. However, the selected fifth level node is not displayed on the history list, as it has no further sub nodes. The apparatus also displays the information relating to the selected fifth level node e.g. on the “description” 542. If the user moves the pointer over “ecology” in the history list, a list of second level nodes 501, 520, 530 in the hierarchy is displayed. If the user moves the pointer over “mammal” in the history list, a list of third level nodes 531, 540 in the hierarchy is displayed. If the user moves the pointer over “cetacea” in the history list, a list of fourth level nodes 541, 545 in the hierarchy is displayed. If the user moves the pointer over “beluga” in the history list, a list of fifth level nodes 542, 543, 544 in the hierarchy is again displayed. At step S610, the user may select one of these second, third, fourth or fifth level nodes, and the process moves back up to the appropriate part of the flowchart.

Thus the user may quickly and easily navigate to any point in the information hierarchy.

FIG. 4 shows a screen layout for a computer screen in a first embodiment of the invention. The screen is divided into an upper section 11 and a lower section 6. The upper section is reserved for displaying a history list to allow a user to navigate back upwards in the hierarchy to a location which they have previously visited. Each item in the history list is allocated a separate box or area of space within the upper section 11 of the screen. The lower section 6 of the screen is used to display the information to the user. When the user moves a pointer over an item on the history list, a sub-menu 12 is displayed, giving a list of information which is immediately below the currently selected information in the hierarchy. When the sub-menu is displayed, all of the information previously displayed in the lower section 6 of the screen may be deleted, or the information may simply be overwritten in the part of the lower section 6 of the screen which is used to display the sub-menu 12. When the pointer is moved away from both the history list and the sub-menu, the sub-menu may remain on the screen, or it may be removed and replaced with the information which was previously displayed in its place.

FIG. 5 shows the screen layout of FIG. 4 together with a number of other screen layouts which show different stages of navigation through different levels of the hierarchical information in the first embodiment of the invention. Arrows are shown connecting the screen layouts, to illustrate how to move from one screen layout to another by clicking the pointer or rolling the pointer over a particular area of the screen. It can be seen in this diagram that a user can navigate back to any level in the hierarchy using the history menu to display new menu items for the next level in the hierarchy below the selected history menu item.

FIG. 6 shows screenshots using the screen layouts of FIG. 5 with an example information source containing information on ecology. This example information source contains information in the structure shown in FIG. 2, along with additional nodes which have not been shown in FIG. 2. FIG. 6 also shows some additional arrows not shown in FIG. 5, to further illustrate how a user may move from one screen to another to navigate through the information hierarchy.

FIGS. 7 to 15 are enlarged views of the screenshots shown in FIG. 6. The method of navigating through the information hierarchy will now be described with reference to FIG. 6, and to these enlarged views of the screenshots.

The screenshot 201 on the top left hand side of FIG. 6 is the default starting screen display. It is also shown in FIG. 7. The history item “Ecology” 13 is shown in a box in the upper part 11 of the screen, and is the only item shown in the history list. “Ecology” is in fact the current item of information. In the lower section 6 of the screen, a piece of information relating to ecology, from the information source, is shown. When a user moves a pointer over the box containing the word “Ecology” 13, the screen display changes to the screenshot 301 shown in FIG. 8.

In FIG. 8, the upper part 11 of the screen is identical to that in FIG. 7. However, the information which had been shown in the lower part of the screen is no longer displayed, and a drop-down menu is displayed in the lower part 6 of the screen. The drop-down menu shows a list of the items of information which are immediately below “Ecology” in the hierarchy. These are “Mammal”, “Birds”, “Fishes”, “Insect” and “Plant”. Each item in the list is displayed in a box, and these boxes are laid out side by side across the entire width of the screen.

If a user clicks the pointer on “Ecology” 13, which is the only entry in the history list, then the drop-down menu disappears, and the screen is updated with the screenshot 201. If instead, a user clicks the pointer on one of the items in the drop-down menu, then that item is selected, and the screen display is updated accordingly. For example, if a user selects “Mammal” 17 in the drop-down menu, screenshot 202 is displayed.

FIG. 9 shows screenshot 202. The history items “Ecology” 13 and “Mammal” 14 are shown in boxes in the upper part 11 of the screen. “Mammal” is the current item of information. In the lower section 6 of the screen, a piece of information relating to mammals is shown. When a user moves a pointer over the box containing the word “Ecology” 13, the screen display changes to the screenshot 301 shown in FIG. 8. When a user moves a pointer over the box containing the word “Mammal” 14, the screen display changes to the screenshot 302 shown in FIG. 10.

In FIG. 10, the upper part 11 of the screen is identical to that in FIG. 9. However, the information which had been shown in the lower part of the screen is no longer displayed, and a drop-down menu is displayed in the lower part 6 of the screen. The drop-down menu shows a list of the items of information which are immediately below “Mammal” in the hierarchy. These are “Cetacea”, “Artiodactla”, “Tubulidentata”, “Xenarthra”, “Pholidota”, “Chiroptera”, “Primates”, “Macroscelidea”, “Rodentia” and “Lagomorpha”. Each item in the list is displayed in a box, and these boxes are laid out side by side in two rows across the entire width of the screen.

If a user clicks the pointer on “Ecology” 13 in the history list, then the drop-down menu disappears, and the screen is updated with the screenshot 201. If a user clicks the pointer on “Mammal” 14 in the history list, then the drop-down menu disappears, and the screen is updated with the screenshot 202. If instead, a user clicks the pointer on one of the items in the drop-down menu, then that item is selected, and the screen display is updated accordingly. For example, if a user selects “Cetacea” 18 in the drop-down menu, screenshot 203 is displayed.

FIG. 11 shows screenshot 203. The history items “Ecology” 13, “Mammal” 14 and “Cetacea” 15 are shown in boxes in the upper part 11 of the screen. “Cetacea” is the current item of information. In the lower section 6 of the screen, a piece of information relating to Cetacea is shown. When a user moves a pointer over the box containing the word “Ecology” 13, the screen display changes to the screenshot 301 shown in FIG. 8. When a user moves a pointer over the box containing the word “Mammal” 14, the screen display changes to the screenshot 302 shown in FIG. 10. When a user moves a pointer over the box containing the word “Cetacea” 15, the screen display changes to the screenshot 303 shown in FIG. 12.

In FIG. 12, the upper part 11 of the screen is identical to that in FIG. 10. However, the information which had been shown in the lower part of the screen is no longer displayed, and a drop-down menu is displayed in the lower part 6 of the screen. The drop-down menu shows a list of the items of information which are immediately below “Cetacea” in the hierarchy. These are “Beluga”, “Irrawaddy Dolphin Beaked Whale”, “Andrews' Beaked Whale”, “Arnoux's Beaked Whale”, “Baird's Beaked Whale”, “Bahamonde's Beaked Whale”, “Blainville's Beaked Whale”, “Cuvier's Beaked Whale”, “Gervais' Beaked Whale”, “Ginkgo-Toothed Beaked Whale”, “Gray's Beaked Whale”, “Hector's Beaked Whale”, “Hubbs' Beaked Whale”, “Lesser Beaked Whale” and “Longman's Beaked Whale”. Each item in the list is displayed in a box, and these boxes are laid out side by side in three rows across the entire width of the screen.

If a user clicks the pointer on “Ecology” 13 in the history list, then the drop-down menu disappears, and the screen is updated with the screenshot 201. If a user clicks the pointer on “Mammal” 14 in the history list, then the drop-down menu disappears, and the screen is updated with the screenshot 202. If a user clicks the pointer on “Cetacea” 15 in the history list, then the drop-down menu disappears, and the screen is updated with the screenshot 203. If instead, a user clicks the pointer on one of the items in the drop-down menu, then that item is selected, and the screen display is updated accordingly. For example, if a user selects “Beluga” 19 in the drop-down menu, screenshot 204 is displayed.

FIG. 13 shows screenshot 204. The history items “Ecology” 13, “Mammal” 14, “Cetacea” 15 and “Beluga” 16 are shown in boxes in the upper part 11 of the screen. “Beluga” is the current item of information. In the lower section 6 of the screen, a piece of information relating to Beluga is shown. When a user moves a pointer over the box containing the word “Ecology” 13, the screen display changes to the screenshot 301 shown in FIG. 8. When a user moves a pointer over the box containing the word “Mammal” 14, the screen display changes to the screenshot 302 shown in FIG. 10. When a user moves a pointer over the box containing the word “Cetacea” 15, the screen display changes to the screenshot 303 shown in FIG. 12. When a user moves a pointer over the box containing the word “Beluga” 16, the screen display changes to the screenshot 304 shown in FIG. 13.

In FIG. 13, the upper part 11 of the screen is identical to that in FIG. 12. However, the information which had been shown in the lower part of the screen is no longer displayed, and a drop-down menu is displayed in the lower part 6 of the screen. The drop-down menu shows a list of the items of information which are immediately below “Beluga” in the hierarchy. These are “Behavour”, “Classification”, “Description”, “Recognition at sea” and “Food & Feeding”. Each item in the list is displayed in a box, and these boxes are laid out side by side in a row across the entire width of the screen.

If a user clicks the pointer on “Ecology” 13 in the history list, then the drop-down menu disappears, and the screen is updated with the screenshot 201. If a user clicks the pointer on “Mammal” 14 in the history list, then the drop-down menu disappears, and the screen is updated with the screenshot 202. If a user clicks the pointer on “Cetacea” 15 in the history list, then the drop-down menu disappears, and the screen is updated with the screenshot 203. If a user clicks the pointer on “Beluga” 16 in the history list, then the drop-down menu disappears, and the screen is updated with the screenshot 204. If instead, a user clicks the pointer on one of the items in the drop-down menu, then that item is selected, and the screen display is updated accordingly. For example, if a user selects “Behaviour” 20 in the drop-down menu, screenshot 205 is displayed.

FIG. 15 shows screenshot 205. The history items “Ecology” 13, “Mammal” 14, “Cetacea” 15 and “Beluga” 16 are shown in boxes in the upper part 11 of the screen. The current item of information, “Behaviour”, is not shown in the history list, because it has no information below it in the information hierarchy, so there is no need for a drop-down menu to show a list of information lower in the hierarchy. In the lower section 6 of the screen, a piece of information relating to Behaviour is shown. When a user moves a pointer over the box containing the word “Ecology” 13, the screen display changes to the screenshot 301 shown in FIG. 8. When a user moves a pointer over the box containing the word “Mammal” 14, the screen display changes to the screenshot 302 shown in FIG. 10. When a user moves a pointer over the box containing the word “Cetacea” 15, the screen display changes to the screenshot 303 shown in FIG. 12. When a user moves a pointer over the box containing the word “Beluga” 16, the screen display changes to the screenshot 304 shown in FIG. 13.

FIG. 16a is a computer screenshot showing an example of how the information store may be stored in the form of directories and subdirectories in a computer file system, with a structure corresponding to the structure of the information hierarchy. This example shows the contents of a directory labelled “Cetacea”. This is not the “Cetacea” directory of FIG. 2, but a separate example. The “Cetacea” directory has nine sub-directories, labelled “blue_whale”, “bowhead_whale”, “fin_whale”, “humpback_whale”, “northern_right whale”, “brydes_whale”, “gray_whale”, “minke_whale” and “sei_whale”. The “Cetacea” directory also contains a file, with filename “image.swf”, which is a Flash movie file. During navigation of the directory structure, in an embodiment of the invention, the “image.swf” file may be automatically played when navigation to the “Cetacea” directory is selected by a user.

FIG. 16b is a computer screenshot showing the contents of the “blue_whale” subdirectory. This subdirectory contains three further subdirectories, labelled “behaviour”, “classification” and “description”. It also contains a Flash movie file, with filename “image.swf”. During navigation of the directory structure, this “image.swf” file may be automatically played when navigation to the “blue_whale” subdirectory is selected by a user. Likewise, other subdirectories may also contain a file, e.g. a Flash movie file or some other type of file, that can be automatically activated or displayed when a user selects navigation to that particular subdirectory.

One alternative way of organising the storage of information from the information source is to use filenames specifying the location of a particular file in the information hierarchy. In that case, files corresponding to more than one level of the information hierarchy, or even all of the files making up the information source, may be stored in a single directory, in one embodiment of the invention.

FIG. 17 shows the contents of a single directory, relating to an information source in an embodiment of the invention. The directory contains no subdirectories, but contains files corresponding to a plurality of levels of the information hierarchy. The filename of each file specifies where in the information hierarchy the file belongs. For example, the file labelled “ecology-image.swf” is a Flash movie file at the top level of the information hierarchy. It may be played automatically in some embodiments of the invention, when the user begins navigation at the top of the hierarchy, or navigates to the top of the hierarchy.

The Flash movie files “ecology-amphibians-image.swf”, “ecology-amphibians-image.swf”, “ecology-birds-image.swf”, “ecology-fishes-image.swf”, “ecology-insect-image.swf”, “ecology-mammal-image.swf” and “ecology-plant-image.swf” each corresponding to a level of the information hierarchy that is immediately below the top level. For example, when a user chooses to navigate to the “Mammal” part of the information hierarchy, the “ecology-mammal-image.swf” file may automatically be played. The apparatus may also detect which files relate to the level immediately below “Mammal” in the hierarchy, by analysis of the filenames, and display these options to the user for further navigation. For example, “ecology-mammal-carnivore-image.swf” is directly below “Mammal” in the information hierarchy, but “ecology-mammal-cetacea-blue_whale-image.swf” is two levels below, and thus would not be displayed as an immediate navigation option in preferred embodiments of the invention.

As can be seen from the above example, a separator such as “-” may be used in the filename to indicate the separation between different parts of the filename corresponding to different levels of the information hierarchy. Alternative separators may be used instead, such as any selected character or character group that is not required for normal use within each part of the filename. Alternatively, a fixed length may be allocated to each part of the filename, to eliminate the need for a separator.

FIG. 18 shows examples of how a filename can be broken down into parts, and used to define the location of the file within an information hierarchy. The first example relates to the filename “ecology-mammal-cetacea-blue_whale-behaviour-image.swf”. The figure indicates how the dashes act as separators, and how the first part “ecology” relates to the title, the second part “mammal” relates to the class, the third part “cetacea” relates to the family, the fourth part “blue_whale” relates to the species name, the fifth part “behaviour” relates to the description, and the sixth part “image.swf” relates to the file format.

The second example of FIG. 18 shows how this type of organisation of a hierarchical information source may be used to allow storage of a user's custom files, or storage of files relating to a particular date and time. Again, a dash is used as a separator, to indicate different levels of the hierarchy. In this example, the filename is “david-2005-07-25-18-24-54-blue whale photo.jpg”, where “david” relates to the user ID, “2005” relates to the year, “07” relates to the month, “25” relates to the date (i.e. day of the month), “18” relates to the hour, “24” relates to the minute, “54” relates to the second, “blue whale photo” relates to the filename, and “jpg” relates to the file format.

This second example illustrates how in some cases, it may be much more convenient to define a hierarchy using filenames or using a label or some sort of list, etc, rather than using an actual directory structure. If a separate directory was used for each individual minute and second, then most directories would contain only a single file. Thus, in certain embodiments, it may be more efficient in terms of file storage to use a labelling system, such as labelling position in the hierarchy with filename, rather than a multi-level directory system to define the structure of the information hierarchy.

FIG. 19 is a schematic diagram indicating the data flow between a navigation interface, an XML processor and data from an information source, in an embodiment of the invention. Information relating to user selection from the information source is passed from the navigation interface to the XML processor. The XML processor then retrieves the appropriate information from the data store. The XML processor processes the information as and if required, e.g. by converting filenames corresponding to subnodes in the information hierarchy into text for displaying to the user. The XML processor then sends the information on to the navigation interface.

The embodiment of FIG. 19 may be used with information that is stored or accessed in any of a plurality of different ways, such as the folder system of FIG. 16A-B, the single directory system of FIG. 17, any system that stores information on the position in the hierarchy within each file or in a separate indexing system, or a system in which at least some of the information is dynamically generated as required and may be accessed in a manner analogous to any of the above file storage systems.

Embodiments similar to that of FIG. 19 may be implemented using an alternative computer language or computer code, instead of or as well as XML. For example, PHP or SQL may be used.

The present invention can be implemented in dedicated hardware, using a programmable digital controller suitably programmed, or using a combination of hardware and software. Thus the present invention can be embodied by any suitable carrier medium for carrying machine readable instructions for controlling a programmable controller. The carrier medium can comprise any storage medium such as a floppy disk, CD ROM, magnetic tape, or programmable memory device, or a transient medium such as an electrical, optical or acoustical signal. An example of such a signal is an encoded signal carrying a computer code over a communications network, e.g. a TCP/IP signal carrying computer code over an IP network such as the Internet, an intranet, or a local area network.

Although specific embodiments of the invention have been described, further modifications are also possible. The code for each process in the methods according to the invention may be modular in the manner shown in the first and second embodiments. Alternatively, the code may be arranged in an alternative way to perform the same function. The methods and apparatus according to the invention are applicable to any computer with display means, and not just a handheld device.

While the invention has been described in terms of what are at present its preferred embodiments, it will be apparent to those skilled in the art that various changes can be made to the preferred embodiments without departing from the scope of the invention, which is defined by the claims.

1. Apparatus for retrieving information from at least one information source, the information being indexed or arranged by an indexing scheme or arrangement that defines an information hierarchy, the apparatus comprising:
a display for displaying information and user selectable menu items;
a user input device for receiving user selections of displayed menu items;
retrieving means for retrieving information from said information source(s); said information source(s) containing information at a plurality of hierarchical levels, said information being distinct from a name of said displayable menu items; and
a display controller adapted to control said display in dependence upon received user selections to display said menu items as history menu items indicating received user selections corresponding to navigation down levels of the hierarchy of said information source(s), and new menu items corresponding to information available at a next level of the hierarchy of said information source(s);
wherein said retrieving means is adapted to retrieve only information corresponding to a most recently selected menu item for a current level of the hierarchy in said information source(s) in response to a most recent user selection, and said display controller is adapted to display said retrieved information for the current level of the hierarchy in a display region separate to said history menu items, whereby the only said information that is displayed in said separate display region is said retrieved information.

2. Apparatus as claimed in claim 1, wherein the display controller is adapted to control the display to display new menu items for a new level of the hierarchy when the user input device receives a history menu item as a user selection.

3. Apparatus as claimed in claim 2, wherein said user input device is adapted to move a pointer, and said display controller is adapted to control the display to display new menu items when a pointer is moved over a history menu item.

4. Apparatus as claimed in claim 1, wherein the display is a touch sensitive screen and the user input device comprises an input component of said touch sensitive screen.

5. Apparatus as claimed in claim 1, wherein said display controller is adapted to control the display to display history menu items as allocated areas of the display arranged in a series.

6. Apparatus as claimed in claim 5, wherein said display controller is adapted to control the display to display the history menu items arranged along an upper area of the display, with the information in a lower area of the display.

7. Apparatus as claimed in claim 1, wherein said display controller is adapted to control the display to display the history menu items in a first area of the display, and a new menu item in a second area of the display when the user input device receives a history menu item as a user selection.

8. Apparatus as claimed in claim 1, wherein said display controller is adapted to control the display to display a new menu item in a lower area of the display when the user input device receives a history menu item as a user selection.

9. Apparatus as claimed in claim 1, wherein said display controller is adapted to control the display to display new menu items overlaying the information displayed on the display.

10. Apparatus as claimed in claim 1, wherein said display controller is adapted to control the display to display new menu items replacing the information displayed on the display.

11. A hand held device comprising the apparatus claimed in claim 1 and said information source.

12. A carrier medium carrying code for configuring a programmable apparatus as the apparatus of claim 1.

13. A method of retrieving information from at least one information source, the information being indexed or arranged by an indexing scheme or arrangement that defines an information hierarchy, the method comprising:
displaying information and user selectable menu items;
receiving user selections of displayed menu items;
retrieving information from said information source(s), said information source(s) containing information at a plurality of hierarchical levels, said information being distinct from a name of said displayable menu items; and
controlling the display of the menu items and the information in dependence upon received user selections to display said menu items as history menu items indicating received user selections corresponding to navigation down levels of the hierarchy of said information source(s) and new menu items corresponding to information available at a next level of the hierarchy of said information source(s),
wherein said retrieving comprises retrieving only information corresponding to a most recently selected menu item for a current level of the hierarchy in said information source(s) in response to a most recent user selection, and said controlling the display comprises displaying said retrieved information for the current level of the hierarchy in a display region separate to said history menu items, whereby the only said information that is displayed in said separate display region is said retrieved information.

14. A method as claimed in claim 13, wherein new menu items are displayed for a new level of the hierarchy when the user input device receives a history menu item as a user selection.

15. A method as claimed in claim 14, wherein said user selections are received by detecting a pointer position, and displaying new menu items when the pointer is detected over a history menu item.

16. A method as claimed in claim 13, wherein said information and user selectable menu items is displayed on a touch sensitive screen and said user selections are received from an input component of said touch sensitive screen.

17. A method as claimed in claim 13, wherein history menu items are displayed in allocated display areas arranged in a series.

18. A method as claimed in claim 17, wherein the history menu items are displayed arranged along an upper display area, and the information is displayed in a lower display area.

19. A method as claimed in claim 13, wherein the history menu items are displayed in a first display area, and a new menu item is displayed in a second display area when the user input device receives a user selection of a history menu item.

20. A method as claimed in claim 13, wherein a new menu item is displayed in a lower display area when the user input device receives a user selection of a history menu item.

21. A method as claimed in claim 13, wherein new menu items are displayed overlaying the displayed information.

22. A method as claimed in claim 13, wherein new menu items are displayed to replacing the displayed information.

23. A method as claimed in claim 13, further comprising
retrieving said information from an information source stored on a handheld device;
displaying said information and user selectable menu items on said hand held device; and
receiving said user selections on said handheld device.

24. A carrier medium carrying code for configuring a programmable apparatus to perform the method of claim 13.
